(19) United States
(12) Patent Application Publication
(10) Pub. No.: US 2026/0022549 A1
(43) Pub. Date: Jan. 22, 2026

(54) SANITARY WASHING DEVICE

(71) Applicant: TOTO LTD., Kitakyushu-shi (JP)

(72) Inventors: Junki HAMADA, Kitakyushu-shi (JP); Yuki KO, Kitakyushu-shi (JP); Katsuya NAGATA, Kitakyushu-shi (JP); Kota YAMASAKI, Kitakyushu-shi (JP)

(21) Appl. No.: 19/265,049

(22) Filed: Jul. 10, 2025

(30) Foreign Application Priority Data
Jul. 17, 2024 (JP) 2024-114238

(51) Int. Cl. E03D 9/08; B05B 15/70

(52) U.S. Cl. CPC E03D 9/08; B05B 15/70

(57) ABSTRACT

A sanitary washing device includes a casing and a nozzle unit configured to advance and retreat between the casing and a toilet. The nozzle unit includes a washing nozzle and a flow channel switch valve. The washing nozzle includes a water discharge port configured to discharge water toward a human body private part, and a flow channel configured to supply water to the water discharge port. The flow channel switch valve is configured to switch the flow channel between flow-enabled and shutoff. The water discharge port is positioned higher than an inlet of the flow channel switch valve when the washing nozzle is stored in a stored state.

### CROSS-REFERENCE TO RELATED APPLICATIONS

This application is based upon and claims the benefit of priority from Japanese Patent Application No. 2024-114238, filed on Jul. 17, 2024; the entire contents of which are incorporated herein by reference.

### FIELD

Embodiments described herein relate generally to a sanitary washing device.

### BACKGROUND

A sanitary washing device that includes a nozzle that advances and retreats with respect to a toilet is known in the art. The sanitary washing device performs a private part wash in which a human body private part is washed by discharging wash water from a water discharge port of the nozzle advanced into the toilet. There are cases where, for example, water may drip from a part of the sanitary washing device such as the water discharge port of the nozzle or the like.

### BRIEF DESCRIPTION OF DRAWINGS

FIG. 1 is a perspective view showing a toilet device including a sanitary washing device according to an embodiment;

FIG. 2 is a block diagram showing relevant components of the sanitary washing device;

FIG. 3 is a schematic perspective view illustrating a private part washing device according to an embodiment;

FIG. 4 is a schematic view illustrating a private part washing device according to an embodiment;

FIG. 5 is a schematic perspective view illustrating a nozzle unit according to an embodiment;

FIG. 6 is a schematic perspective view illustrating a supporter according to an embodiment;

FIG. 7 is a schematic perspective view illustrating a main part of the supporter according to an embodiment;

FIG. 8 is a schematic top view illustrating the main part of the supporter according to an embodiment;

FIG. 9 is a schematic perspective view illustrating a cover part of a supporter according to an embodiment;

FIG. 10 is a schematic side view illustrating a part of a private part washing device according to an embodiment;

FIG. 11 is a schematic cross-sectional view illustrating a nozzle unit according to an embodiment;

FIG. 12 is a schematic top view illustrating a part of a private part washing device according to an embodiment;

FIG. 13 is a schematic top view illustrating a part of a private part washing device according to an embodiment; and

FIG. 14 is a schematic top view illustrating a part of a private part washing device according to an embodiment.

### DETAILED DESCRIPTION

A first invention is a sanitary washing device including a casing and a nozzle unit configured to advance and retreat between the casing and a toilet; the nozzle unit includes a washing nozzle and a flow channel switch valve; the washing nozzle includes a water discharge port configured to discharge water toward a human body private part, and a flow channel configured to supply water to the water discharge port; the flow channel switch valve is configured to switch the flow channel between flow-enabled and shutoff; and the water discharge port is positioned higher than an inlet of the flow channel switch valve when the washing nozzle is stored in a stored state.

According to the sanitary washing device, the water discharge port is positioned higher than the inlet when the washing nozzle is in the stored state, and so dripping of water from the water discharge port can be suppressed.

A second invention is the sanitary washing device of the first invention, wherein the flow channel has an upwardly convex shape; the flow channel includes a top, a first inclined portion, and a second inclined portion; the first inclined portion descends frontward from the top when the washing nozzle is in the stored state; the second inclined portion descends backward from the top when the washing nozzle is in the stored state; and the top is positioned higher than the water discharge port and the inlet when the washing nozzle is in the stored state.

According to the sanitary washing device, water can collect in an area of the flow channel upstream of the top; and dripping of the water remaining inside the washing nozzle from the water discharge port can be further suppressed.

A third invention is the sanitary washing device of the first or second invention that further includes a body wash flow channel configured to supply water to a nozzle wash part; the nozzle wash part is configured to wash the washing nozzle by discharging water toward the washing nozzle; the flow channel switch valve is configured to switch the body wash flow channel between flow-enabled and shutoff; and an outlet of the body wash flow channel is positioned higher than the inlet of the flow channel switch valve when the washing nozzle is in the stored state.

According to the sanitary washing device, the outlet of the body wash flow channel is positioned higher than the inlet when the washing nozzle is in the stored state, and so dripping of water from the nozzle wash part can be suppressed.

A fourth invention is the sanitary washing device of the third invention that further includes a water supply flow channel configured to supply water to the inlet of the flow channel switch valve; and the water supply flow channel and the body wash flow channel are connected to the flow channel switch valve and configured so that the water supply flow channel and the body wash flow channel are curved with mutually-different curvatures.

According to the sanitary washing device, the curvatures of the water supply flow channel and the body wash flow channel are different from each other, and so the timing at which loads are applied to the drive motor advancing and retracting the nozzle unit can be dispersed, and the peak load of the drive motor can be suppressed.

Exemplary embodiments will now be described with reference to the drawings. Similar components in the drawings are marked with like reference numerals; and a detailed description is omitted as appropriate.

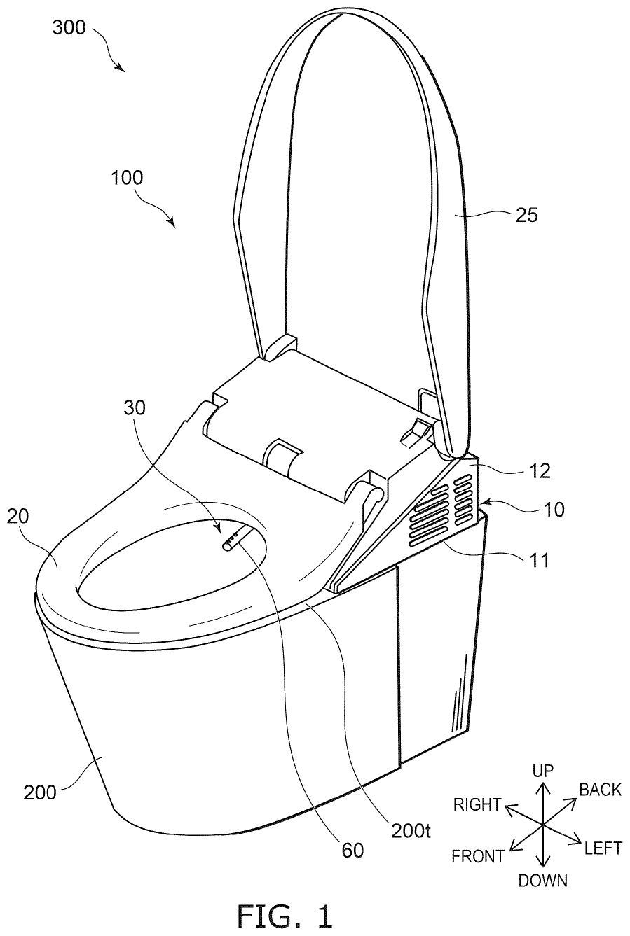

FIG. 1 is a perspective view showing a toilet device including a sanitary washing device according to an embodiment.

As shown in FIG. 1, the toilet device 300 according to the embodiment includes the sanitary washing device 100 and a western-style sit-down toilet 200 (hereinbelow, called simply the “toilet” 200 for convenience of description). The sanitary washing device 100 is disposed on the toilet 200. The sanitary washing device 100 includes a private part washing device 30 for washing a private part of a user seated on a toilet seat 20.

A casing 10 includes a case plate 11 and a case cover 12. The case plate 11 forms the bottom part of the casing 10. The case plate 11 is placed on the back part of the toilet 200. The case cover 12 is disposed on the case plate 11 and covers the top of the case plate 11. The toilet seat 20 and a toilet lid 25 are pivotally supported by the case cover 12 to be rotatable.

The casing 10 stores the private part washing device 30 inside a space surrounded with the case plate 11 and the case cover 12. Functional units such as, for example, an opening/closing unit that controls the open/close operations of the toilet seat 20 and the toilet lid 25, a toilet seat heating unit that controls the temperature of the toilet seat 20, a communication unit that can communicate with an operation unit, etc., are stored inside the casing 10.

In this specification, “up/upward/above”, “down/downward/below”, “front/frontward/forward”, “back/backward/behind”, “right/rightward”, and “left/leftward” are directions when viewed by a user sitting on the toilet seat 20 with the user's back facing the toilet lid 25 as shown in FIG. 1. “Longitudinal” means “frontward and/or backward”, and “lateral” means “leftward and/or rightward”.

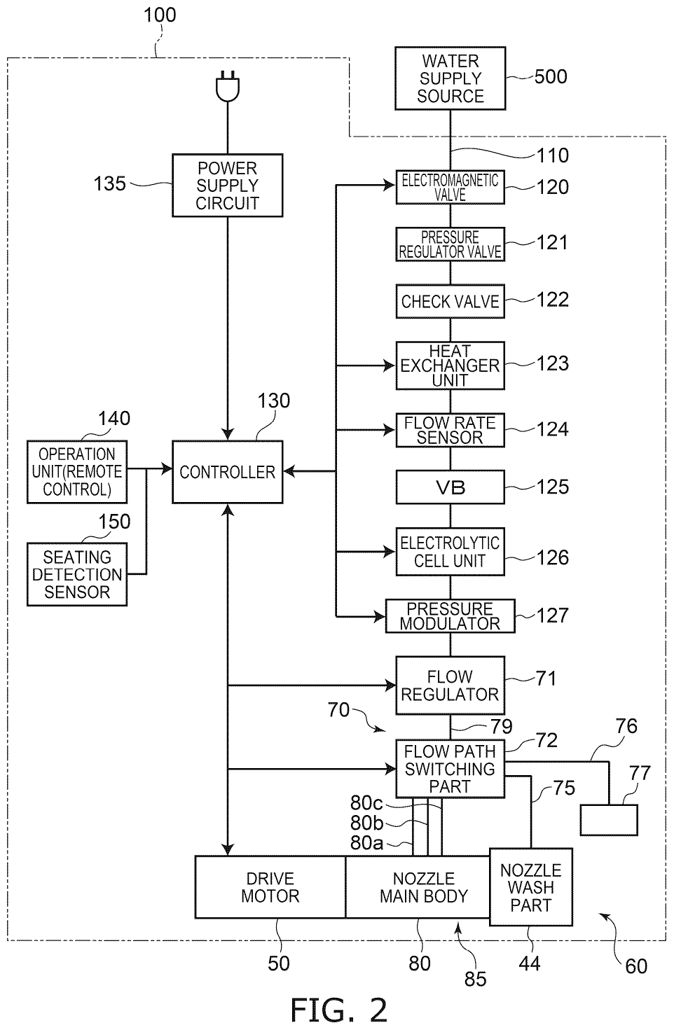

FIG. 2 is a block diagram showing relevant components of the sanitary washing device.

FIG. 2 shows relevant components of both a water channel system and an electrical system of the sanitary washing device 100.

As shown in FIG. 2, the sanitary washing device 100 includes a pipe line 110. The pipe line 110 extends to a nozzle unit 60 from a water supply source 500 such as a service water line, a water storage tank, etc. The pipe line 110 guides the water supplied from the water supply source 500 to the nozzle unit 60.

An electromagnetic valve 120 is disposed at the upstream side of the pipe line 110. The electromagnetic valve 120 is an openable and closable electromagnetic valve and controls the supply of the water based on a command from a controller 130 disposed inside the casing 10. In other words, the electromagnetic valve 120 opens and closes the pipe line 110. The water that is supplied from the water supply source 500 is caused to flow in the pipe line 110 by setting the electromagnetic valve 120 to the open state.

A pressure regulator valve 121 is disposed downstream of the electromagnetic valve 120. The pressure regulator valve 121 regulates the pressure inside the pipe line 110 to be within a prescribed pressure range when the water supply pressure is high. A check valve 122 is disposed downstream of the pressure regulator valve 121. The check valve 122 suppresses the backflow of water toward the upstream side of the check valve 122 when the pressure inside the pipe line 110 drops, etc.

A heat exchanger unit 123 (a heater) is disposed downstream of the check valve 122. The heat exchanger unit 123 includes a heater and heats the water supplied from the water supply source 500 to a specified temperature. In other words, the heat exchanger unit 123 produces warm water.

The heat exchanger unit 123 is, for example, an instant heating-type (instantaneous-type) heat exchanger that uses a ceramic heater, etc. Compared to a warm water storage heating-type heat exchanger that uses a warm water storage tank, the instant heating-type heat exchanger can heat the water to the specified temperature in a short period of time. The heat exchanger unit 123 is not limited to an instant heating-type heat exchanger and may be a warm water storage heating-type heat exchanger. The heater is not limited to a heat exchanger; for example, another heating technique such as one that utilizes microwave heating, etc., may be used.

The heat exchanger unit 123 is connected with the controller 130. For example, the controller 130 heats the water to a temperature set by an operation unit 140 by controlling the heat exchanger unit 123 according to an operation of the operation unit 140 by the user.

A flow rate sensor 124 is disposed downstream of the heat exchanger unit 123. The flow rate sensor 124 detects the flow rate of the water discharged from the heat exchanger unit 123. In other words, the flow rate sensor 124 detects the flow rate of the water flowing through the pipe line 110. The flow rate sensor 124 is connected to the controller 130. The flow rate sensor 124 inputs the detection result of the flow rate to the controller 130.

A vacuum breaker (VB) 125 is disposed downstream of the flow rate sensor 124. The vacuum breaker 125 includes, for example, a flow channel for allowing the water to flow, an intake for drawing air into the flow channel, and a valve mechanism that opens and closes the intake. For example, the valve mechanism blocks the intake when water is flowing in the flow channel, and draws air into the flow channel by opening the intake when the flow of the water stops. In other words, the vacuum breaker 125 draws air into the pipe line 110 when the water does not flow in the pipe line 110. The valve mechanism includes, for example, a float valve.

The vacuum breaker 125 draws air into the pipe line 110, thereby promoting, for example, water drainage of the part of the pipe line 110 downstream of the vacuum breaker 125. For example, the vacuum breaker 125 promotes the water drainage of the nozzle unit 60. Thus, the vacuum breaker 125 drains the water inside the nozzle unit 60 and draws air into the nozzle unit 60, thereby suppressing, for example, the undesirable backflow to the water supply source 500 (the fresh water) side of the wash water inside the nozzle unit 60, etc.

An electrolytic cell unit 126 is disposed downstream of the vacuum breaker 125. The electrolytic cell unit 126 generates a liquid (functional water) including hypochlorous acid from the tap water by electrolyzing the tap water flowing through the interior of the electrolytic cell unit 126. The electrolytic cell unit 126 is connected to the controller 130. The electrolytic cell unit 126 generates functional water based on a control by the controller 130.

The functional water that is generated by the electrolytic cell unit 126 may be, for example, a solution including metal ions such as silver ions, copper ions, etc. Or, the functional water that is generated by the electrolytic cell unit 126 may be a solution including electrolytic chlorine, ozone, etc. Or, the functional water that is generated by the electrolytic cell unit 126 may be acidic water or alkaline water.

A pressure modulator 127 is disposed downstream of the electrolytic cell unit 126. The pressure modulator 127 applies a pulsatory motion to the water discharged from the water discharge port of a washing nozzle 85 and the water discharge port of a nozzle wash part 44 by applying a pulsatory motion or an acceleration to the flow of the water inside the pipe line 110. In other words, the pressure modulator 127 causes the fluidic state of the water flowing through the pipe line 110 to fluctuate. The pressure modulator 127 is connected to the controller 130. The pressure modulator 127 causes the fluidic state of the water to fluctuate based on a control by the controller 130. The pressure modulator 127 causes the pressure of the water inside the pipe line 110 to fluctuate.

A flow regulator 71 and a flow channel switch valve 70 (a flow channel switching device) are disposed downstream of the pressure modulator 127. The flow regulator 71 (the flow regulating valve) regulates the water force (the flow rate). The flow channel switch valve 70 is disposed downstream of the flow regulator 71. The flow channel switch valve 70 is connected with a water supply flow channel 79. Water is supplied from the upstream side to the flow channel switch valve 70 via the water supply flow channel 79.

The flow channel switch valve 70 includes a flow path switching part 72. The flow path switching part 72 performs opening, closing, and switching of the water supply to a nozzle main body 80 of the washing nozzle 85 and/or the nozzle wash part 44. The flow regulator 71 and the flow path switching part 72 are connected to the controller 130. The operations of the flow regulator 71 and the flow path switching part 72 are controlled by the controller 130.

Multiple flow channels (a bottom wash channel 80a, a gentle wash channel 80b, a bidet wash channel 80c, a body wash flow channel 75, and a spout flow channel 76) are connected downstream of the flow channel switch valve 70 (the flow path switching part 72). The bottom wash channel 80a, the gentle wash channel 80b, and the bidet wash channel 80c are disposed inside the nozzle main body 80. The bottom wash channel 80a, the gentle wash channel 80b, and the bidet wash channel 80c are flow channels supplying water to water discharge ports that discharge the water toward human body private parts. In other words, the washing nozzle 85 discharges the water supplied from the flow path switching part 72 via the bottom wash channel 80a, the gentle wash channel 80b, and the bidet wash channel 80c.

The body wash flow channel 75 is a pipe line that connects between the flow channel switch valve 70 and the nozzle wash part 44. The nozzle wash part 44 discharges the water supplied from the flow path switching part 72 toward the outer perimeter surface (the body) of the washing nozzle 85 via the body wash flow channel 75. As a result, the nozzle wash part 44 washes the washing nozzle 85.

The spout flow channel 76 is a pipe line connecting the flow channel switch valve 70 and a spout part 77. The spout part 77 is, for example, a nozzle that turns the water supplied from the flow path switching part 72 via the spout flow channel 76 into a mist and sprays the mist into the bowl of the toilet 200. Dirt can be prevented from adhering inside the toilet 200 by spraying the water into the bowl.

The flow path switching part 72 switches the opening and closing of the flow channels of the bottom wash channel 80a, the gentle wash channel 80b, the bidet wash channel 80c, the body wash flow channel 75, and the spout flow channel 76. By opening each flow channel, the flow channel is set to a flow-enabled state in which water is supplied and flows. By closing each flow channel, the flow channel is set to a water shutoff state in which the supply of the water is stopped (e.g., a state in which water does not flow).

The flow path switching part 72 switches each of multiple water discharge ports such as the water discharge ports in the washing nozzle 85, the water discharge port in the nozzle wash part 44, etc., between a state of communicating with the pipe line 110 and a state of not communicating with the pipe line 110. The flow channel that is enabled to carry water among the multiple flow channels connected downstream of the flow channel switch valve 70 is switched by the flow channel switch valve 70 (the flow path switching part 72). In other words, the flow channel switch valve 70 selects the flow channel that supplies water to the downstream side among the multiple flow channels connected downstream of the flow channel switch valve 70.

The controller 130 is, for example, a control circuit that includes an electrical circuit such as a CPU (Central Processing Unit), etc. The controller 130 is supplied with power from a power supply circuit 135 and controls operations of the electromagnetic valve 120, the heat exchanger unit 123, the electrolytic cell unit 126, the pressure modulator 127, the flow regulator 71, the flow path switching part 72, a drive motor 50, etc., based on signals from a seating detection sensor 150, the flow rate sensor 124, the operation unit 140, etc. As a result, the controller 130 controls the operation of the nozzle unit 60.

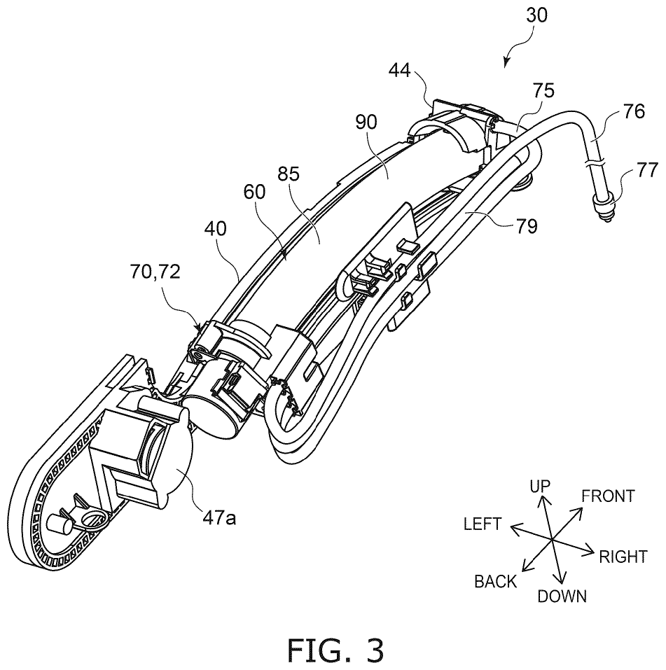

FIG. 3 is a schematic perspective view illustrating a private part washing device according to an embodiment.

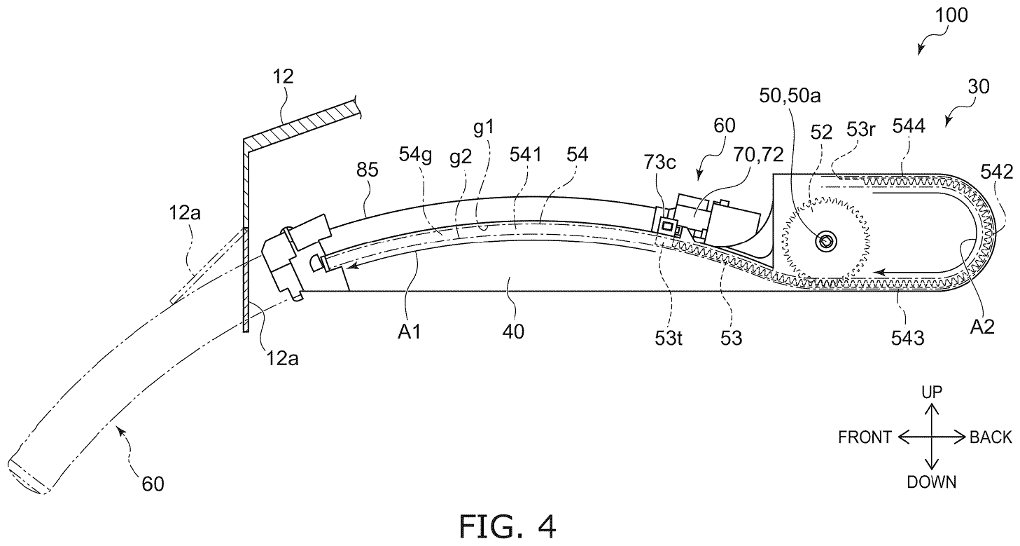

FIG. 4 schematically illustrates the private part washing device 30 of the sanitary washing device 100 when viewed from the left. As illustrated in FIG. 4, the private part washing device 30 includes the nozzle unit 60, a rack 53, a gear 52, the drive motor 50, and a rack guide 54.

The nozzle unit 60 is curved to be upwardly convex. The nozzle unit 60 includes the washing nozzle 85 and the flow channel switch valve 70 (the flow path switching part 72) positioned at the back of the washing nozzle 85. The flow channel switch valve 70 is connected to the back end of the washing nozzle 85, which is curved to be upwardly convex.

The nozzle unit 60 advances and retreats between the toilet 200 and the casing 10 described with reference to FIG. 1. With the exception of the double dot-dash lines, FIGS. 3 and 4 illustrate a stored state in which the nozzle unit 60 is at a retracted position. In the stored state, the tip of the nozzle unit 60 is positioned behind the front end of the case cover 12, and is positioned below the case cover 12. For example, in the stored state, the nozzle unit is 60 positioned behind an openable/closable lid 12a included in the case cover 12, and is stored between the case cover 12 and the case plate 11 (see FIG. 1). The retracted position is, for example, the most backward position within the range of movement of the nozzle unit 60. When viewed in side-view as illustrated in FIG. 4, the back part of the washing nozzle 85 is inclined upward toward the front; and the front part of the washing nozzle 85 is inclined downward toward the front. That is, for example, in the stored state, the upper end (the top) of the washing nozzle 85 or the nozzle unit 60 is positioned at the middle of the nozzle unit 60 in the longitudinal direction.

The double dot-dash lines in FIG. 4 illustrate the washing nozzle 85 and the openable/closable lid 12a when the nozzle unit 60 is in an advanced state in which the nozzle unit 60 is moved to an advanced position. In the advanced state, the tip of the nozzle unit 60 is positioned further forward than the front end of the case cover 12. For example, the tip of the nozzle unit 60 in the advanced state is positioned further forward than the openable/closable lid 12a and is advanced to a position inside the toilet 200 and further forward than the casing 10. When the nozzle unit 60 advances into the toilet 200, the openable/closable lid 12a is pressed open by the tip of the nozzle unit 60. The advanced position is, for example, the most frontward position within the range of movement of the nozzle unit 60. The tip of the nozzle unit 60 in the advanced state is further forward and lower than the tip of the nozzle unit 60 in the stored state.

The rack 53 is a flexible rack (a cable rack). The rack 53 is flexible enough to move through the curved rack guide 54 (a passageway 54g). The rack 53 may include, for example, a resin. The rack 53 includes a tip part 53t, which is a front end part, and a back end 53r, which is the end at the side opposite to the tip part 53t in the extension direction along the rack guide 54. The tip part 53t of the rack 53 is connected to an engaging part 73c of the nozzle unit 60.

The gear 52 is a substantially circular gear when viewed in side-view. The teeth of the gear 52 engage the teeth of the rack 53. Multiple teeth configured to engage the gear 52 are arranged at the surface of the rack 53 at the gear 52 side, and are arranged in the extension direction of the rack 53. The rack 53 is a rack gear that converts rotational motion of the gear 52 into linear motion.

The drive motor 50 engages the gear 52. The gear 52 is mounted to the rotary shaft of the drive motor 50. The drive force of the drive motor 50 is transmitted to the rack 53 via the gear 52 and moves the rack 53. The drive motor 50 advances and retracts the nozzle unit 60 by moving the rack 53.

The rack 53 is guided by the rack guide 54 when moved by the drive force of the drive motor 50. The rack guide 54 is a part configured to contain the rack 53 and holds the rack 53 so that the rack 53 is slidable. The rack guide 54 defines the passageway 54g (the trajectory of the rack 53) through which the rack 53 moves.

More specifically, the rack guide 54 includes a first guide surface g1 and a second guide surface g2 that guide the rack 53. The space between the first guide surface g1 and the second guide surface g2 is used as the passageway 54g. The rack 53 slides along the first guide surface g1 and the second guide surface g2 by abutting the first guide surface g1 and the second guide surface g2.

For example, when the gear 52 is rotated clockwise by the drive motor 50 from the stored state shown in FIG. 4, the rack 53 is moved frontward through the curved rack guide 54 from the position illustrated in FIG. 4. In other words, the tip part 53t of the rack 53 is moved frontward along arrow A1 through the arc-like trajectory inside a first curved portion 541 of the rack guide 54. The back end 53r of the rack 53 is moved along arrow A2 from a linear portion 544 of the rack guide 54 to a linear portion 543 via a second curved portion 542. The nozzle unit 60 is advanced toward the interior of the toilet 200 by the rack 53 pressing the engaging part 73c frontward.

On the other hand, for example, the rack 53 is moved backward when the gear 52 is rotated counterclockwise from the state in which the rack 53 has been moved frontward and the nozzle unit 60 is in the advanced state. The rack 53 is moved backward through the curved rack guide 54 to return to the position illustrated in FIG. 4. In other words, the tip part 53t of the rack 53 is moved backward along the opposite direction of arrow A1 through the arc-like trajectory inside the first curved portion 541 of the rack guide 54. The back end 53r of the rack 53 is moved along the opposite direction of arrow A2 from the linear portion 543 of the rack guide 54 toward the linear portion 544 via the second curved portion 542. The nozzle unit 60 is retracted inside the casing 10 by the rack 53 pulling the engaging part 73c backward.

Thus, the nozzle unit 60 can be moved along an arc-like trajectory between the advanced position and the retracted position by the drive force of the drive motor 50 transmitted via the gear 52 and the rack 53.

The private part washing device 30 further includes a supporter 40. For example, the supporter 40 is fixed with respect to the casing 10 (see FIG. 1). The supporter 40 supports the nozzle unit 60 so that the nozzle unit 60 is slidable. The supporter 40 is positioned below the nozzle unit 60 and supports the nozzle unit 60 from below.

The supporter 40 is positioned so that the supporter 40 is higher than, for example, an upper surface 200t (a rim surface; see FIG. 1) of the toilet 200. For example, the nozzle unit 60 is higher than the upper surface 200t when the nozzle unit 60 is in the stored state. As a result, penetration of liquid waste into the private part washing device 30 can be suppressed, and the supporter 40 and/or the nozzle unit 60 can be prevented from becoming dirty.

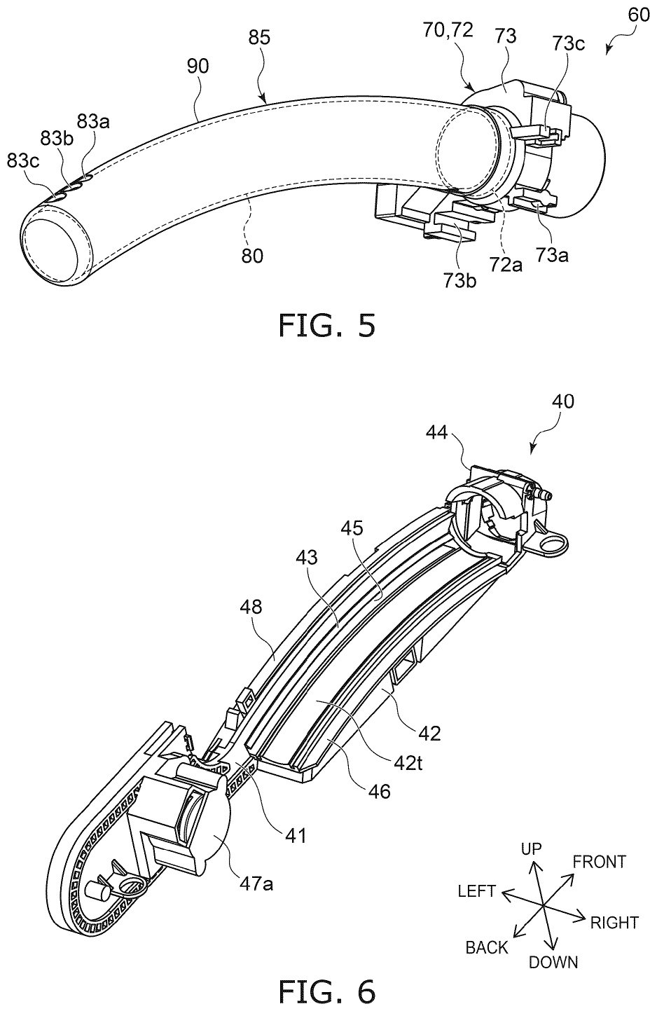

FIG. 5 is a schematic perspective view illustrating a nozzle unit according to an embodiment.

The washing nozzle 85 includes the nozzle main body 80 that has a curved (or bent) tubular shape, and a nozzle cover 90 that has a curved cylindrical shape covering the outer perimeter of the nozzle main body 80.

Water discharge ports (a bottom wash water discharge port 83a, a gentle wash water discharge port 83b, and a bidet wash water discharge port 83c) that discharge water toward human body private parts above the water discharge port in the advanced state of the nozzle unit 60 are formed in the tip of the washing nozzle 85. The bottom wash channel 80a, the gentle wash channel 80b, and the bidet wash channel 80c that are schematically illustrated in FIG. 2 are disposed in the nozzle main body 80.

The bottom wash channel 80a allows water to flow from the flow path switching part 72 to the bottom wash water discharge port 83a. The bottom wash water discharge port 83a discharges the water supplied from the flow path switching part 72 via the bottom wash channel 80a.

The gentle wash channel 80b allows water to flow from the flow path switching part 72 to the gentle wash water discharge port 83b. The gentle wash water discharge port 83b discharges the water supplied from the flow path switching part 72 via the gentle wash channel 80b.

The bidet wash channel 80c allows water to flow from the flow path switching part 72 to the bidet wash water discharge port 83c. The bidet wash water discharge port 83c discharges the water supplied from the flow path switching part 72 via the bidet wash channel 80c.

For example, the flow channel switch valve 70 is continuous with the back end of the nozzle main body 80. The flow channel switch valve 70 includes a case 73 that stores the flow path switching part 72. The flow path switching part 72 includes a valve main body 72a. For example, a rotor and a stator can be used as the valve main body 72a. For example, the stator is disk-shaped and has ports (openings) connected respectively to the flow channels. The rotor is disk-shaped and is arranged to face the stator at the upstream side of the stator. A drive mechanism that includes an electromotor such as a motor, a solenoid, etc., rotates the rotor. The rotor switches the ports between a closed state and an open state by rotating in contact with the stator. By closing each port, the flow channel that is connected with the port is switched to a water shutoff state. By opening each port, the flow channel that is connected with the port is switched to a flow-enabled state. The configuration is not limited thereto, and the flow path switching part 72 may have any configuration that can switch the flow channel that allows the water to flow.

For example, the case 73 is mounted to the nozzle main body 80. A part of the case 73 may be formed as one piece with a part of the nozzle main body 80. The nozzle cover 90 is mounted to the case 73 and the nozzle main body 80. As a result, the nozzle unit 60 slides, with the flow channel switch valve 70, the nozzle main body 80, and the nozzle cover 90 as one piece, in the longitudinal direction with respect to the supporter 40.

Thus, by curving the washing nozzle 85 to be upwardly convex, the washing nozzle can be advanced to a lower position in the advanced state while suppressing the height (the width in the vertical direction) in the stored state. In other words, a nozzle unit that has high washing performance can be provided while suppressing the height.

The case 73 includes a protrusion 73a and a recess 73b. The protrusion 73a and the recess 73b are engaging parts that engage parts (a groove part 45 and a rail part 46 described below) of the supporter 40. The protrusion 73a protrudes outward from the outer perimeter of the case 73. The recess 73b is disposed at the outer perimeter of the case 73.

In the example, the engaging part 73c that connects the nozzle unit 60 to the rack 53 (see FIG. 4) is included in the case 73. The engaging part 73c is a protrusion protruding sideward from the outer perimeter of the case 73.

FIG. 6 is a schematic perspective view illustrating a supporter according to an embodiment.

The supporter 40 includes a main part 41 and a cover part 48 that covers the side of the main part 41.

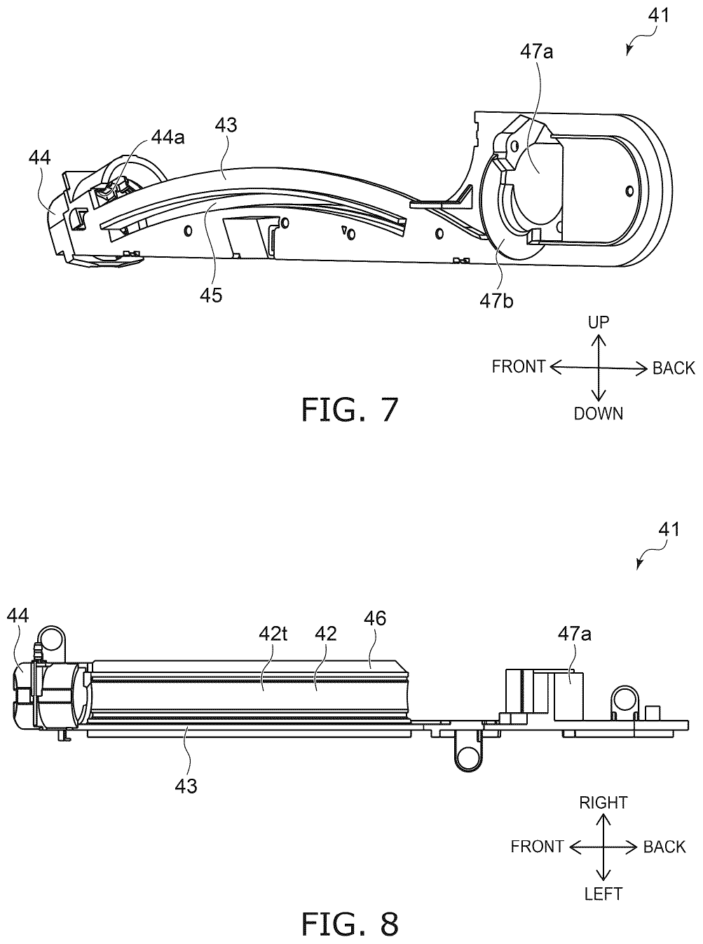

FIG. 7 is a schematic perspective view illustrating a main part of the supporter according to the embodiment.

FIG. 8 is a schematic top view illustrating the main part of the supporter according to the embodiment.

For example, as illustrated in FIG. 6, the main part 41 includes a nozzle placement part 42, a vertical part 43, and the nozzle wash part 44. The nozzle placement part 42 is, for example, a bottom part of the main part 41 and extends in the longitudinal direction. The nozzle placement part 42 is a part on which the nozzle unit 60 is disposed in the stored state. The shape of an upper surface 42t of the nozzle placement part 42 is curved to be upwardly convex to correspond to the shape of the nozzle cover 90. The nozzle unit 60 is curved along the upper surface 42t in the stored state. In other words, the nozzle unit 60 is stored above the upper surface 42t of the nozzle placement part 42 along the upper surface 42t. For example, the upper surface 42t has a smoothly curved shape, and may be curved with a constant curvature.

The vertical part 43 has a plate shape extending upward from the nozzle placement part 42. The vertical part 43 is curved to be upwardly convex to correspond to the shape of the nozzle cover 90.

For example, as illustrated in FIG. 7, the supporter 40 includes the groove part 45 extending in the advance/retreat direction of the nozzle unit 60. In the example, the groove part 45 is a slit-shaped opening extending through the vertical part 43 in the thickness direction (the lateral direction) and extending in the longitudinal direction. The groove part 45 is curved to be upwardly convex to correspond to the shape of the nozzle cover 90.

For example, as illustrated in FIG. 6 or FIG. 8, the supporter 40 includes the rail part 46 that extends in the advance/retreat direction of the nozzle unit 60. The rail part 46 has a plate shape that protrudes in the lateral direction from the nozzle placement part 42 and extends in the longitudinal direction. The rail part 46 is curved to be upwardly convex to correspond to the shape of the nozzle cover 90.

The groove part 45 and the rail part 46 are engaged parts that are engaged by parts of the nozzle unit 60. The groove part 45 and the rail part 46 are parts that guide the nozzle unit 60 when the nozzle unit 60 is advanced and retracted between the interior of the casing 10 and the interior of the toilet 200.

In other words, the protrusion 73a of the nozzle unit 60 (see FIG. 5) is configured to be inserted into the groove part 45 and to engage the groove part 45. The protrusion 73a is held to be slidable along the groove part 45. The recess 73b of the nozzle unit 60 (see FIG. 5) engages the rail part 46 by being configured so that the rail part 46 is interposed in the recess 73b. The recess 73b is held to be slidable along the rail part 46. Thus, the nozzle unit 60 is held by the groove part 45 and the rail part 46 to be slidable with respect to the supporter 40. The nozzle unit 60 advances and retreats along an arc-like trajectory because the groove part 45 and the rail part 46 are curved along the longitudinal direction.

As illustrated in FIGS. 6 to 8, the nozzle wash part 44 is disposed at the front end side of the nozzle placement part 42 and the vertical part 43. In the example, the nozzle wash part 44 is included as a part of the main part 41. The nozzle wash part 44 covers the outer perimeter of the nozzle cover 90. A water discharge port 44a (see FIG. 7) is formed in the inner perimeter side of the nozzle wash part 44. Water is supplied to the nozzle wash part 44 through the flow path switching part 72 by the body wash flow channel 75. The nozzle wash part 44 discharges the water supplied by the body wash flow channel 75 toward the nozzle cover 90 of the washing nozzle 85 from the water discharge port 44a. As a result, the nozzle wash part 44 washes the outer perimeter surface (the body) of the nozzle cover 90.

For example, in the example as illustrated in FIG. 8, the supporter 40 includes a motor placement part 47a. The motor placement part 47a is disposed further back than the nozzle placement part 42 of the main part 41 and covers the drive motor 50. In other words, the drive motor 50 is contained inside the motor placement part 47a of the supporter 40.

As illustrated in FIG. 7, the supporter 40 includes a gear placement part 47b. The gear placement part 47b is adjacent to the motor placement part 47a at a side of the motor placement part 47a. The gear 52 is disposed in the gear placement part 47b. In other words, the gear 52 is contained inside the supporter 40 and positioned at the side surface of the main part 41.

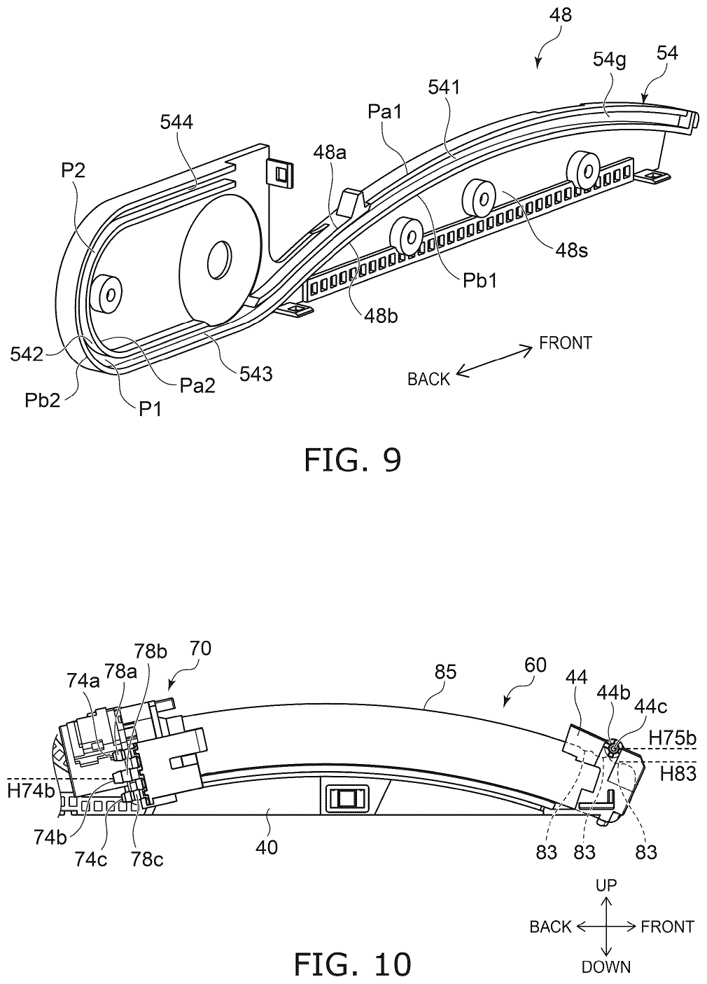

FIG. 9 is a schematic perspective view illustrating a cover part of a supporter according to an embodiment.

In the example, the rack guide 54 and the supporter 40 are one piece. In other words, the rack guide 54 is included in the supporter 40. The supporter 40 of the nozzle unit 60 also is used as the supporter of the rack guide 54.

For example, a space defined by the cover part 48 (see FIG. 9) and the main part 41 (see FIG. 7) is used as the passageway 54g of the rack guide 54. The cover part 48 and at least a part of the rack guide 54 are one piece; and the cover part 48 is formed as one piece that includes at least a part of the rack guide 54.

More specifically, as illustrated in FIG. 9, the supporter 40 includes a first protrusion 48a and a second protrusion 48b. The space between the first protrusion 48a and the second protrusion 48b is used as the passageway 54g of the rack guide 54. The first protrusion 48a and the second protrusion 48b protrude in the lateral direction from the side surface of the supporter 40 (in the example, a side surface 48s of the cover part 48) and extend in the longitudinal direction.

The first protrusion 48a includes a front portion Pa1 and a back portion Pa2. The front portion Pa1 is curved to be upwardly convex when viewed in side-view and extends in the longitudinal direction. The back portion Pa2 is positioned further back than the front portion Pa1, and includes a portion that is curved to extend upward and backward. The first guide surface g1 described with reference to FIG. 4 is a surface of the first protrusion 48a.

The second protrusion 48b is curved similarly to the first protrusion 48a and extends along the first protrusion 48a to surround the outer side of the first protrusion 48a. The second protrusion 48b includes a front part Pb1 adjacent to the front portion Pa1 of the first protrusion 48a, and a back part Pb2 adjacent to the back portion Pa2 of the first protrusion 48a. The second protrusion 48b has a curved shape that is parallel to the first protrusion 48a at a prescribed distance from the first protrusion 48a. The second guide surface g2 described with reference to FIG. 4 is a surface of the second protrusion 48b.

Accordingly, the rack guide 54 (the passageway 54g) includes the first curved portion 541 and the second curved portion 542. The first curved portion 541 is curved to be upwardly convex to correspond to the shape of the washing nozzle 85. The first curved portion 541 corresponds to the passageway between the front portion Pa1 and the front part Pb1. For example, the first curved portion 541 is curved with a constant curvature. For example, the first curved portion 541 is curved along the upper surface 42t of the nozzle placement part 42 (see FIG. 6) and has a curved shape that is parallel to the upper surface 42t at a prescribed distance from the upper surface 42t. The curvature of the first curved portion 541 may be substantially equal to the curvature of the upper surface 42t when viewed in side-view. The first curved portion 541 includes an upward inclined portion inclined upward and backward, and a downward inclined portion that is continuous from the back end of the upward inclined portion and is inclined downward and backward.

The second curved portion 542 is positioned further back than the first curved portion 541. The second curved portion 542 includes a portion that is bent in a direction crossing the longitudinal direction as the second curved portion 542 extends backward. The second curved portion 542 corresponds to a passageway between the back portion Pa2 and the back part Pb2. In the example, the second curved portion 542 is a folded portion that extends in the longitudinal direction, is folded back, and is convex backward when viewed in side-view. In other words, the second curved portion 542 includes a portion P1 bent upward as the second curved portion 542 extends backward. The second curved portion 542 includes a portion P2 that is continuous from the upper end of the portion P1 and is curved upward as the second curved portion 542 extends frontward. For example, the second curved portion 542 is curved with a constant curvature.

For example, at least a portion of the first curved portion 541 and at least a portion of the second curved portion 542 are arranged along a straight line extending in the longitudinal direction when viewed in side-view. In the example, the position of the first curved portion 541 in the vertical direction is such that the first curved portion 541 is between the upper end and the lower end of the second curved portion 542 (the folded portion).

The rack guide 54 may further include the linear portion 543 and the linear portion 544. The linear portion 543 connects the first curved portion 541 and the second curved portion 542 and extends linearly in the longitudinal direction. The gear 52 positioned between the first curved portion 541 and the second curved portion 542 meshes with the rack 53 in the linear portion 543. The linear portion 544 extends linearly frontward from the upper end of the second curved portion 542.

Although the first protrusion 48a and the second protrusion 48b are included in the cover part 48 in the example of FIG. 9, at least portions of the first and second protrusions 48a and 48b may be included in the main part 41 side. The main part 41 and at least a part of the rack guide 54 may be one piece; and the main part 41 may be formed as one piece that includes at least a part of the rack guide 54. At least portion of the passageway 54g of the rack guide 54 may be formed as a groove (a recess) formed in the side surface of the supporter 40.

For example, as illustrated in FIG. 4 above, when the nozzle unit 60 is in the stored state, the washing nozzle 85 is adjacent to the first curved portion 541 in the lateral direction and positioned further forward than the second curved portion 542. The washing nozzle 85 is curved along the first curved portion 541 when the nozzle unit 60 is in the stored state. Because the washing nozzle 85 can be stored along the first curved portion 541, the height of the sanitary washing device 100 can be further suppressed.

The curvature of the washing nozzle 85 (the nozzle cover 90) may be equal to the curvature of the first curved portion 541 when viewed in side-view. For example, the first curved portion 541 has a curved shape that is parallel to the washing nozzle 85 (the nozzle cover 90) in the stored state.

When the nozzle unit 60 is in the stored state, the washing nozzle 85 is disposed above the upper surface 42t of the nozzle placement part 42 described in FIG. 6, etc. Thus, the curved washing nozzle 85 is disposed on the curved upper surface 42t of the supporter 40. As a result, the washing nozzle 85 can be advanced frontward and downward; and water can be discharged from a lower position during the private part wash. Therefore, a nozzle unit that has a high washing performance can be provided while suppressing the height.

FIG. 10 is a schematic side view illustrating a part of a private part washing device according to an embodiment.

FIG. 10 illustrates parts of the nozzle unit 60 and the supporter 40 when the nozzle unit 60 is in the stored state when viewed laterally.

As illustrated in FIG. 10, the flow channel switch valve 70 of the nozzle unit 60 includes a spout outlet 74a, an inlet 74b, and a body wash outlet 74c. For example, the spout outlet 74a, the inlet 74b, and the body wash outlet 74c are formed in the case 73 that stores the flow path switching part 72, and are openings that communicate with the flow path switching part 72 inside the case 73.

In the example, a protrusion 78a, a protrusion 78b, and a protrusion 78c are attaching parts for the flow channels and are disposed at the right side surface of the case 73. In the stored state, the protrusion 78a, the protrusion 78b, and the protrusion 78c protrude backward and downward. The protrusion 78a is positioned above the protrusion 78b; and the protrusion 78b is positioned above the protrusion 78c. The spout outlet 74a, the inlet 74b, and the body wash outlet 74c are openings formed respectively in the back ends of the protrusions 78a, 78b, and 78c. The inlet 74b is an inlet through which water flows into the nozzle unit 60; and the spout outlet 74a and the body wash outlet 74c are outlets through which water flows from the nozzle unit 60.

The water supply flow channel 79 that supplies water to the inlet 74b (see FIG. 3) is connected to the protrusion 78b. The water that is supplied from the upstream side to the nozzle unit 60 via the water supply flow channel 79 flows through the inlet 74b into the flow channel switch valve 70 and flows toward the flow path switching part 72.

The body wash flow channel 75 (see FIG. 3) is connected to the protrusion 78c. When the flow path switching part 72 opens the body wash flow channel 75, the water flowing into the flow channel switch valve 70 flows out from the flow path switching part 72 to the body wash flow channel 75 via the body wash outlet 74c.

The spout flow channel 76 (see FIG. 3) is connected to the protrusion 78a. When the flow path switching part 72 opens the spout flow channel 76, the water flowing into the flow channel switch valve 70 flows out from the flow path switching part 72 to the spout flow channel 76 via the spout outlet 74a.

The water supply flow channel 79, the body wash flow channel 75, and the spout flow channel 76 are flexible tubes (or hoses) that are formed of, for example, a resin material. The protrusion 78c (the body wash outlet 74c), the protrusion 78b (the inlet 74b), and the protrusion 78a (the spout outlet 74a) are connection ports of the tubes. The connection ports and the tubes are connected so that the connection ports are inserted into the tubes.

The nozzle wash part 44 includes a wash part inlet 44c. In the example, a protrusion 44b, which is an attaching part of the flow channel, is disposed at the right side surface of the nozzle wash part 44. The protrusion 44b protrudes rightward. The wash part inlet 44c is an opening at the right end of the protrusion 44b. The protrusion 44b (the wash part inlet 44c) is a connection port of a flexible tube. As described above, one end (the inlet) of the body wash flow channel 75 is connected to the protrusion 78c (the body wash outlet 74c). The other end (an outlet 75p; see FIG. 12) of the body wash flow channel 75 is connected to the protrusion 44b (the wash part inlet 44c). The water that flows through the body wash outlet 74c into the body wash flow channel 75 flows through the wash part inlet 44c into the nozzle wash part 44.

When the washing nozzle 85 is stored in the stored state, a water discharge port 83 of the washing nozzle 85 is positioned higher than the inlet 74b of the flow channel switch valve 70. In other words, a height H74b (the vertical-direction position) of the inlet 74b is lower than a height H83 (the vertical-direction position) of the water discharge port 83. The water discharge port 83 is a water discharge port that discharges water toward a human body private part, and is, for example, the bottom wash water discharge port 83a, the gentle wash water discharge port 83b, or the bidet wash water discharge port 83c described above. For example, in the stored state, the inlet 74b is positioned lower than all of the water discharge ports 83 formed in the washing nozzle 85.

Because the water discharge port 83 is positioned higher than the inlet 74b when the washing nozzle 85 (the nozzle unit 60) is in the stored state, dripping of water from the water discharge port 83 can be suppressed. For example, it is easy to form an inclined portion in the flow channel from the inlet 74b to the water discharge port 83 so that the inclined portion descends backward when the washing nozzle 85 is in the stored state. Therefore, for example, the water that remains inside the washing nozzle 85 is prevented from dripping from the water discharge port 83 at the front at an unintended timing.

When the washing nozzle 85 is in the advanced state, the water discharge port 83 is positioned lower than the inlet 74b. For example, the water that is inside the nozzle can be discharged through the water discharge port 83 by advancing the washing nozzle 85. For example, water drainage can be performed at the desired timing.

When the washing nozzle 85 is stored in the stored state, the outlet of the body wash flow channel 75 also is positioned higher than the inlet 74b of the flow channel switch valve 70. As described above, the outlet of the body wash flow channel 75 is connected to the wash part inlet 44c. A height H75b (the vertical-direction position) of the outlet of the body wash flow channel 75 illustrated in FIG. 10 is substantially the same as the position of the wash part inlet 44c. The height H74b of the inlet 74b is lower than the height H75b of the outlet of the body wash flow channel 75.

Because the outlet of the body wash flow channel 75 is positioned higher than the inlet 74b when the washing nozzle 85 is in the stored state, dripping of water from the nozzle wash part 44 can be suppressed. For example, it is easy to form an inclined portion in the flow channel from the inlet 74b of the flow channel switch valve 70 to the outlet of the body wash flow channel 75 so that the inclined portion descends backward when the washing nozzle 85 is in the stored state. Therefore, for example, the water that remains inside the body wash flow channel 75 is prevented from dripping from the water discharge port 44a. For example, water can be prevented from dripping from the body wash flow channel 75 at an unintended timing. The height H74b of the inlet 74b may be lower than the height (the vertical-direction position) of the water discharge port 44a of the nozzle wash part 44.

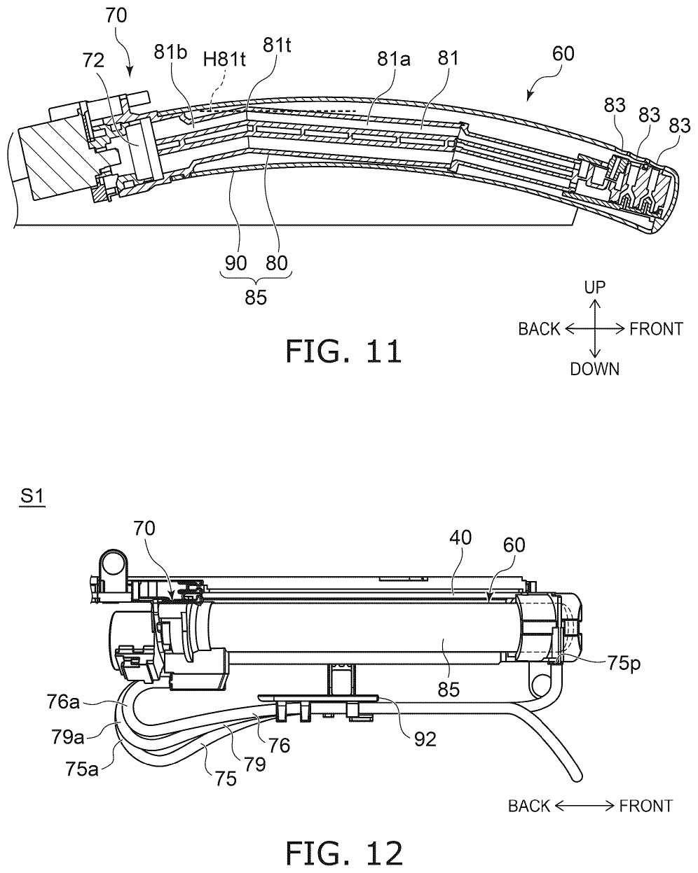

FIG. 11 is a schematic cross-sectional view illustrating a nozzle unit according to an embodiment.

FIG. 11 illustrates the nozzle unit in the stored state. A flow channel 81 that supplies water to the water discharge port 83 is disposed inside the nozzle main body 80 of the washing nozzle 85. For example, the nozzle main body 80 and the flow channel 81 have bent shapes that are upward convex in the stored state.

The flow channel 81 includes a top 81t, a first inclined portion 81a, and a second inclined portion 81b. The top 81t is the portion of the flow channel 81 positioned at the highest position in the stored state. The flow channel 81 is bent at the top 81t. The first inclined portion 81a is a pipe line that descends frontward, i.e., a downward inclined portion that is inclined downward toward the front, from the top 81t in the stored state. The second inclined portion 81b is a pipe line that descends backward, i.e., an upward inclined portion that is inclined upward toward the front, from the top 81t in the stored state. The top 81t is the portion at which the flow channel 81 changes from the upward incline to the downward incline in the stored state. Water flows through the flow channel 81 from the first inclined portion 81a toward the second inclined portion 81b and is discharged through the water discharge port 83.

When the nozzle unit 60 is in the stored state, the top 81t of the flow channel 81 is higher than the water discharge port 83 supplied with water by the flow channel 81, and higher than the inlet 74b of the flow channel switch valve 70. In other words, a height H81t (the vertical-direction position) of the top 81t is higher than the height H83 of the water discharge port 83 and higher than the height H74b of the inlet 74b. Water can collect in the area of the flow channel 81 upstream of the top 81t; and the water that remains inside the washing nozzle 85 can be further prevented from dripping from the water discharge port 83.

The flow channel 81 is, for example, the bottom wash channel 80a, the gentle wash channel 80b, or the bidet wash channel 80c. For example, the top 81t of the bottom wash channel 80a is positioned higher than the bottom wash water discharge port 83a and the inlet 74b in the stored state. For example, the top 81t of the gentle wash channel 80b is positioned higher than the gentle wash water discharge port 83b and the inlet 74b in the stored state. For example, the top 81t of the bidet wash channel 80c is positioned higher than the bidet wash water discharge port 83c and the inlet 74b in the stored state.

FIGS. 12 to 14 are schematic top views illustrating a part of a private part washing device according to an embodiment.

FIG. 12 illustrates a first state S1 in which the nozzle unit 60 is positioned at a first position with respect to the supporter 40. The first state S1 is, for example, the stored state of the nozzle unit 60.

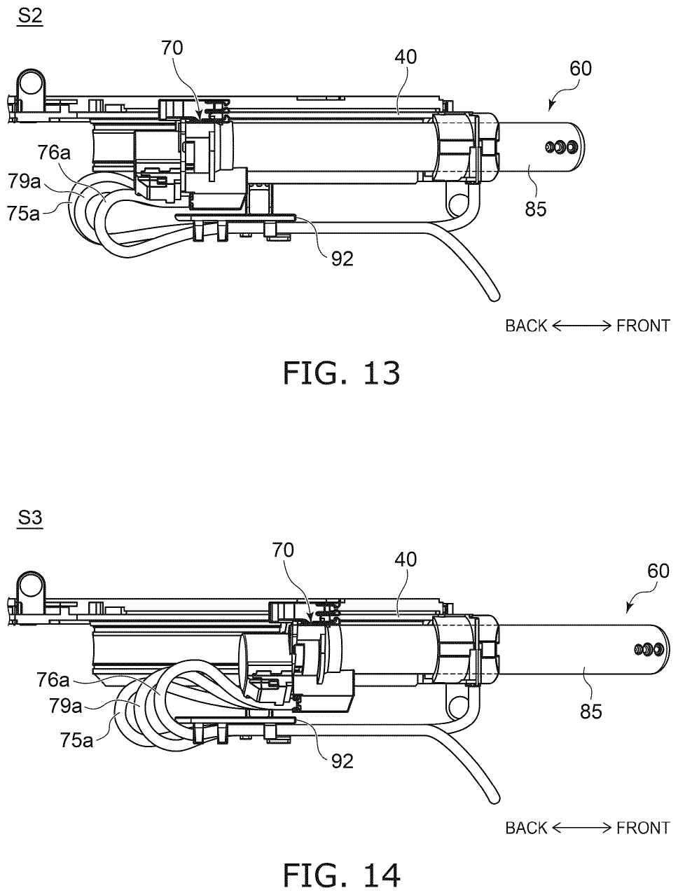

FIG. 13 illustrates a second state S2 in which the nozzle unit 60 is advanced frontward from the first state S1; and FIG. 14 illustrates a third state S3 in which the nozzle unit 60 is advanced further forward from the second state S2.

In each of the first to third states S1 to S3, the body wash flow channel 75 includes a curved portion 75a; the water supply flow channel 79 includes a curved portion 79a; and the spout flow channel 76 includes a curved portion 76a. The curved portion 75a, the curved portion 79a, and the curved portion 76a are curved to be backwardly convex behind the washing nozzle 85.

One end of the curved portion 75a is connected to the body wash outlet 74c of the flow channel switch valve 70; and the other end of the curved portion 75a extends frontward. In other words, the body wash flow channel 75 is attached to extend backward from the flow channel switch valve 70 and to be folded back toward the front at the curved portion 75a.

One end of the curved portion 79a is connected to the inlet 74b of the flow channel switch valve 70; and the other end of the curved portion 79a extends frontward. In other words, the water supply flow channel 79 is attached to extend backward from the flow channel switch valve 70 and to be folded back toward the front at the curved portion 79a.

One end of the curved portion 76a is connected to the spout outlet 74a of the flow channel switch valve 70; and the other end of the curved portion 76a extends frontward. In other words, the spout flow channel 76 is attached to extend backward from the flow channel switch valve 70 and to be folded back toward the front at the curved portion 76a.

A portion of the body wash flow channel 75 further forward than the curved portion 75a, a portion of the water supply flow channel 79 further forward than the curved portion 79a, and a portion of the spout flow channel 76 further forward than the curved portion 76a are held by a holding member 92 or are positionally fixed with respect to the supporter 40 by the holding member 92. For example, the holding member 92 is attached to the supporter 40; and the position of the holding member 92 with respect to the supporter 40 is fixed.

In each of the first to third states S1 to S3, the curvature of the curved portion 75a, the curvature of the curved portion 79a, and the curvature of the curved portion 76a are different from each other. For example, in the first state S1, the curvature radius of the curved portion 76a is less than the curvature radius of the curved portion 79a; and the curvature radius of the curved portion 79a is less than the curvature radius of the curved portion 75a. For example, in the second state S2, the curvature radius of the curved portion 79a is less than the curvature radius of the curved portion 76a; and the curvature radius of the curved portion 76a is less than the curvature radius of the curved portion 75a. For example, in the third state S3, the curvature radius of the curved portion 75a is less than the curvature radius of the curved portion 76a; and the curvature radius of the curved portion 76a is less than the curvature radius of the curved portion 79a.

The timing at which the curvature of the curved portion 75a is a maximum, the timing at which the curvature of the curved portion 79a is a maximum, and the timing at which the curvature of the curved portion 76a is a maximum are different from each other. For example, the curvature radius of the curved portion 76a is greater in the second state S2 than in the first state S1, and greater in the third state S3 than in the second state S2. For example, the curvature radius of the curved portion 79a is greater in the first state S1 than in the second state S2, and greater in the third state S3 than in the first state S1. For example, the curvature radius of the curved portion 75a is greater in the second state S2 than in the third state S3, and greater in the first state S1 than in the second state S2.

Thus, each tube bends (the manner in which each tube is bent changes) as the nozzle unit 60 advances and retreats. When the nozzle unit 60 advances and retreats, a sliding resistance is generated according to the bend of the tube; and a load is applied to the drive motor 50. When the nozzle unit 60 advances and retreats, the timing at which the force corresponding to the bend of the tube has a peak changes according to the curvature of the tube at that time.

In contrast, the body wash flow channel 75, the water supply flow channel 79, and the spout flow channel 76 are connected to the flow channel switch valve 70 and configured to be curved with mutually-different curvatures. As a result, the timing at which the loads are applied to the drive motor 50 is dispersed, and the peak load of the drive motor 50 can be suppressed. For example, when the nozzle unit 60 advances and retreats, the timing at which the force (the motor load) corresponding to the bend of the body wash flow channel 75 is a maximum, the timing at which the force corresponding to the bend of the water supply flow channel 79 is a maximum, and the timing at which the force corresponding to the bend of the spout flow channel 76 is a maximum can be shifted from each other. For example, even a small drive motor 50 can control the advance and retreat of the nozzle unit 60; and the nozzle unit 60 can have a low height.

Embodiments may include the following configurations.

### Configuration 1

A sanitary washing device, comprising:
a casing; and
a nozzle unit configured to advance and retreat between the casing and a toilet,
the nozzle unit including
   a washing nozzle including
      a water discharge port configured to discharge water toward a human body private part, and
      a flow channel configured to supply water to the water discharge port, and
   a flow channel switch valve configured to switch the flow channel between flow-enabled and shutoff,
the water discharge port being positioned higher than an inlet of the flow channel switch valve when the washing nozzle is in a stored state.

### Configuration 2

The sanitary washing device according to Configuration 1, wherein
the flow channel has an upwardly convex shape,
the flow channel includes a top, a first inclined portion, and a second inclined portion,
the first inclined portion descends frontward from the top when the washing nozzle is in the stored state,
the second inclined portion descends backward from the top when the washing nozzle is in the stored state, and
the top is positioned higher than the water discharge port and the inlet when the washing nozzle is in the stored state.

### Configuration 3

The sanitary washing device according to Configuration 1 or 2, further comprising:
a body wash flow channel configured to supply water to a nozzle wash part, the nozzle wash part being configured to wash the washing nozzle by discharging water toward the washing nozzle,
the flow channel switch valve being configured to switch the body wash flow channel between flow-enabled and shutoff,
an outlet of the body wash flow channel being positioned higher than the inlet of the flow channel switch valve when the washing nozzle is in the stored state.

### Configuration 4

The sanitary washing device according to Configuration 3, further comprising:
a water supply flow channel configured to supply water to the inlet of the flow channel switch valve,
the water supply flow channel and the body wash flow channel being connected to the flow channel switch valve and configured so that the water supply flow channel and the body wash flow channel are curved with mutually-different curvatures.

The invention has been described with reference to the embodiments. However, the invention is not limited to these embodiments. Any design changes in the above embodiments suitably made by those skilled in the art are also encompassed within the scope of the invention as long as they fall within the spirit of the invention. For example, the shape, the size the material, the disposition and the arrangement or the like of the components are not limited to illustrations and can be changed appropriately.

The components included in the embodiments described above can be combined to the extent possible, and these combinations are also encompassed within the scope of the invention as long as they include the features of the invention.

What is claimed is:

1. A sanitary washing device, comprising:
a casing; and
a nozzle unit configured to advance and retreat between the casing and a toilet,
the nozzle unit including
a washing nozzle including
a water discharge port configured to discharge water toward a human body private part, and
a flow channel configured to supply water to the water discharge port, and
a flow channel switch valve configured to switch the flow channel between flow-enabled and shutoff,
the water discharge port being positioned higher than an inlet of the flow channel switch valve when the washing nozzle is in a stored state.

2. The sanitary washing device according to claim 1, wherein
the flow channel has an upwardly convex shape,
the flow channel includes a top, a first inclined portion, and a second inclined portion,
the first inclined portion descends frontward from the top when the washing nozzle is in the stored state,
the second inclined portion descends backward from the top when the washing nozzle is in the stored state, and
the top is positioned higher than the water discharge port and the inlet when the washing nozzle is in the stored state.

3. The sanitary washing device according to claim 1, further comprising:
a body wash flow channel configured to supply water to a nozzle wash part, the nozzle wash part being configured to wash the washing nozzle by discharging water toward the washing nozzle,
the flow channel switch valve being configured to switch the body wash flow channel between flow-enabled and shutoff,
an outlet of the body wash flow channel being positioned higher than the inlet of the flow channel switch valve when the washing nozzle is in the stored state.

4. The sanitary washing device according to claim 3, further comprising:
a water supply flow channel configured to supply water to the inlet of the flow channel switch valve,
the water supply flow channel and the body wash flow channel being connected to the flow channel switch valve and configured so that the water supply flow channel and the body wash flow channel are curved with mutually-different curvatures.
